(19) United States
(12) Patent Application Publication
(10) Pub. No.: US 2009/0120650 A1
(43) Pub. Date: May 14, 2009

(54) Removable Horseshoe Clip

(76) Inventor: Lawrence Ronald Daine, Edwardsville, IL (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 11/938,667

(22) Filed: Nov. 12, 2007

(51) Int. Cl. A01L 7/00

(52) U.S. Cl. 168/4

(57) ABSTRACT

A removable horseshoe clip for temporarily placement on a horseshoe during the fitment process to secure the horseshoe against slipping or rotational movement during nailing, and method of use. The removable horseshoe clip includes an inner retaining clip sized to engage the inner peripheral edge of a horseshoe, a broad base for seating against the bottom surface of the horseshoe, and an outer retaining clip adapted to abut the outer peripheral edge of a horseshoe and the outer surface of a hoof wall.

### CROSS-REFERENCE TO RELATED APPLICATIONS

Not Applicable.

### STATEMENT REGARDING FEDERALLY SPONSORED RESEARCH

Not Applicable.

### BACKGROUND OF THE INVENTION

The present application is related generally to the attachment of horseshoes to an equine hoof, and in particular, to a clip which may be temporarily secured to a horseshoe during the shoeing procedure to facilitate proper placement and alignment of the horseshoe relative to the equine hoof, and which may be subsequently removed from the horseshoe after attachment of the horseshoe to the equine hoof.

Horseshoes have traditionally been utilized to provide traction and protection to the hooves of equines. A standard horse shoe, such as shown in FIG. 1A is formed from metal, typically a soft steel or aluminum, but may be of materials as well. The front or leading edge of the horseshoe is known as the toe, while the trailing arms or portions are known as the heels. When attached to a hoof, the heel portion closest to horse's body centerline is referred to as the inside (medial) heel, while the opposite heel portion is referred to as the outside (lateral) heel.

Equine hoof structure and shape may vary from animal to animal, as well as from hoof to hoof on a single horse, and hence, it is common practice for a farrier to adjust the shape of each individual horseshoe to fit the particular hoof prior to nailing. Adjustment may be done by cold forming, i.e., hammering alone, or in combination with heating. Once a horseshoe is sized and fitted to a hoof, nails, such as shown in FIG. 2, are driven through the nail holes in the horseshoe and into the tough outer hoof wall of the equine hoof. Generally, the nails are of sufficient length such that the tip of the nail will protrude through the outer surface of the hoof wall above the horseshoe, allowing the tip to be cut off and bent over to form a clinch which retains the nail in the hoof wall. The sequence in which the nails are driven through the horseshoe and into the hoof wall during attachment is important to ensure the proper placement of the horseshoe relative to the equine hoof structures. The shape of the nail is configured to ensure that the nails will penetrate the hoof wall at an outward incline, ensuring that they are not directed inward towards the sensitive internal structures of the equine hoof.

On a plain horseshoe, such as shown in FIG. 1A, the initial nails are driven into the hoof wall through the nail holes which are closest to the heel on each side to prevent the horseshoe from sliding backwards relative to the hoof during the driving of the nails. However, when one nail is driven in on one side of the horseshoe, the nail may act as a pivot, and the horseshoe may shift or torque about that location, requiring the farrier to hammer on the side of the horseshoe to return it to the desired position before continuing. Hammering on the side of the horseshoe risks a bruising injury to the equine hoof in the event the hammer misses or slips from the horseshoe upon impact, and potentially weakens the hold of the nails which are already driven into place by twisting them within the hoof wall and widening the passage in which they rest.

Some horseshoes, such as shown in FIG. 1B, are formed with one or more permanent clips raised from the upper peripheral edges of the horseshoe. Upon proper fitment of the horseshoe to an equine hoof, the raised clips align along the outer surface of the hoof wall, and serve to prevent the shoe from sliding backwards relative to the hoof during application and use. However, permanent clips increase the cost of production for the horseshoes, and/or require additional time for the farrier to make the clips and properly align them with the hoof surfaces. Permanent clips pose a potential for injury to the hoof structures in the event the horseshoe slips or loosens during use, allowing the raised clip to rotate inward towards the center of the hoof and posing a risk of penetrating puncture injuries.

Accordingly, it would be advantageous to provide a method and means for attaching a horseshoe to an equine hoof which prevents slipping and rotating of the horseshoe during nailing, which does not increase the cost of producing the horseshoe, the time required for preparation of the horseshoe, or pose a potential for injury to the hoof structures after attachment of the horseshoe to an equine hoof.

### BRIEF SUMMARY OF THE INVENTION

Briefly stated, the present disclosure provides a removable horseshoe clip which may be placed temporarily on a horseshoe during the fitment process to secure the horseshoe against slipping or rotational movement during nailing. The removable horseshoe clip includes an inner retaining clip sized to engage the inner peripheral edge of a horseshoe, a broad base for seating against the bottom surface of the horseshoe, and an outer retaining clip adapted to abut the outer peripheral edge of a horseshoe and the outer surface of a hoof wall.

The present disclosure further provides a method for facilitating the attachment of horseshoes to an equine hoof utilizing one or more removable horseshoe clips. The method requires the initial step of sizing and fitting of the horseshoe to the equine hoof. Prior to driving nails or other attachment means to secure the horseshoe to the equine hoof, one or more removable horseshoe clips are engaged with the horseshoe. The removable horseshoe clips are positioned to avoid interference with the required placement for the nails or other attachment means, and to provide for an abutting engagement with the outer hoof surfaces when the horseshoe is disposed against the equine hoof in the desired placement position. The horseshoe is then secured to the equine hoof using nails or other attachment means, while the abutting engagement between the horseshoe clip with the hoof outer surface prevents sliding and rotating movement of the horseshoe. Once the horseshoe is secured to the equine hoof, the removable horseshoe clips are released from the horseshoe which is subsequently retained in place by the nails or other attachment means.

The foregoing features, and advantages set forth in the present disclosure as well as presently preferred embodiments will become more apparent from the reading of the following description in connection with the accompanying drawings.

### BRIEF DESCRIPTION OF THE SEVERAL VIEWS OF THE DRAWINGS

In the accompanying drawings which form part of the specification:

FIG. 1A is a perspective view of a prior art horseshoe without integrally formed clips;

FIG. 1B is a perspective view of a prior art horseshoe with a pair of integrally formed clips;

FIG. 2 is a prior art side view of a horseshoe nail, enlarged to illustrate the angled surfaces adapted to direct the inclination of the nail through a hoof wall;

FIG. 3 is a perspective view of a removable horseshoe clip of the present disclosure;

FIG. 4 is a bottom view of the clip of FIG. 3;

FIG. 5 is a top view of the clip of FIG. 3;

FIG. 6 is a cross-sectional view of the clip of FIG. 5, taken along line 6-6;

FIG. 7 is a perspective view illustrating the use of a pair of the removable horseshoe clips of FIG. 3 with a horseshoe of FIG. 1A;

FIG. 8 is a bottom view of the horseshoe and clips shown in FIG. 7;

FIG. 9 is a side view of an equine hoof during attachment of the horseshoe shown in FIG. 7;

FIG. 10 is a front view of an equine hoof during attachment of the horseshoe shown in FIG. 7;

FIG. 11 is a perspective view illustrating the use of a single removable horseshoe clip of FIG. 3 with a horseshoe of FIG. 1A;

FIG. 12 is a bottom view of the horseshoe and clip shown in FIG. 11;

FIG. 13 is a side view of an equine hoof during attachment of the horseshoe shown in FIG. 11; and

FIG. 14 is a front view of an equine hoof during attachment of the horseshoe shown in FIG. 11.

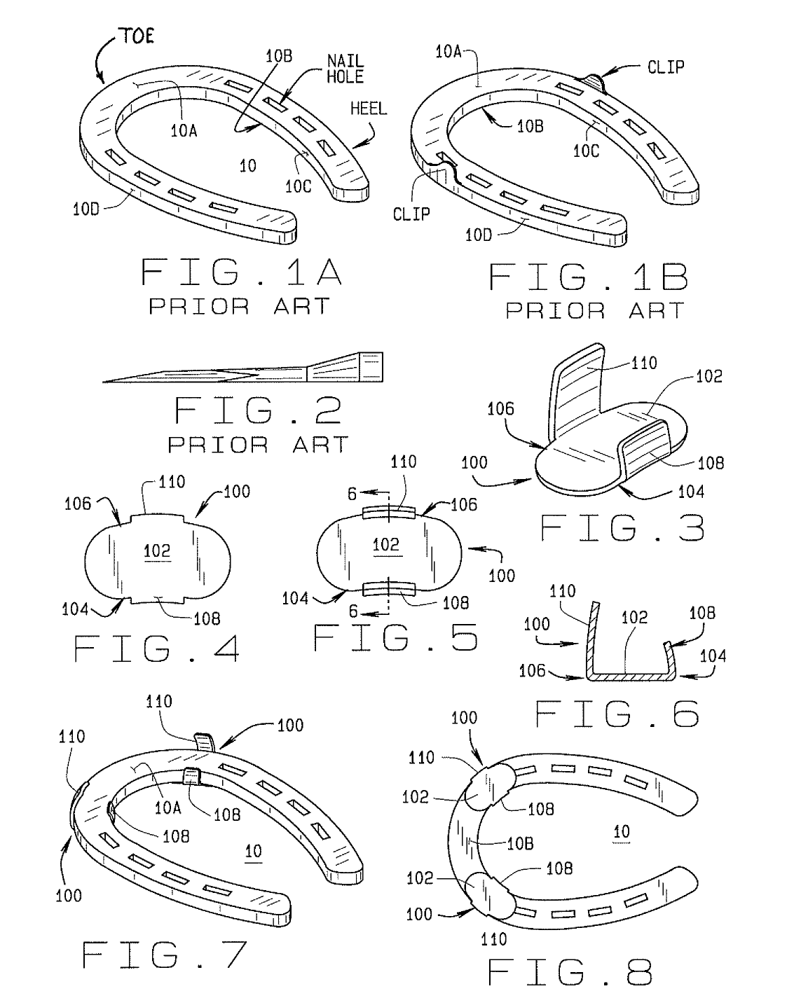

Corresponding reference numerals indicate corresponding parts throughout the several figures of the drawings. It is to be understood that the drawings are for illustrating the concepts set forth in the present disclosure and are not to scale.

Before any embodiments of the invention are explained in detail, it is to be understood that the invention is not limited in its application to the details of construction and the arrangement of components set forth in the following description or illustrated in the drawings.

### DETAILED DESCRIPTION

The following detailed description illustrates the invention by way of example and not by way of limitation. The description enables one skilled in the art to make and use the present disclosure, and describes several embodiments, adaptations, variations, alternatives, and uses of the present disclosure, including what is presently believed to be the best mode of carrying out the present disclosure.

Turning to the figures, and in particular to FIGS. 3-6, a removable horseshoe clip of the present disclosure is shown generally at 100. The clip 100 is adapted for temporary placement on a horseshoe 10 having a top surface 10A, a bottom surface 10B, an inner peripheral surface 10C, and an outer peripheral surface 10D during fitment and attachment of the horseshoe to an equine hoof. The clip 100 consists of a planar base portion 102 having an inner peripheral edge 104 adapted to align with an edge of the inner peripheral surface 10C of the horseshoe 10, and an outer peripheral edge 106 adapted to align with an edge of the outer peripheral surface 10D of the horseshoe 10. Generally, the width of the planar base portion 102 is selected to correspond to the width of the horseshoe 10 for which the clip 100 is sized to fit.

At least one inner retaining clip 108 is disposed adjacent to the inner peripheral edge 104, and extends generally upward from the planar base portion 102. The inner retaining clip 108 has a height which is selected to correspond approximately to, or slightly greater than, the thickness of the horseshoe 10 for which the clip 100 is sized to fit, and is inclined inward towards the center of the planar base portion 102, as best seen in FIG. 6.

At least one outer retaining clip 110 is disposed adjacent to the outer peripheral edge 106, and extends generally upward from the planar base portion 102. The outer retaining clip 110 has a height which exceeds the thickness of the horseshoe 10 for which the clip 100 is sized to fit. The height of the outer retaining clip 110 is selected such that a portion of the outer retaining clip 110 will abut an exterior surface of an equine hoof during use, and which is preferably at least twice the thickness of the horseshoe 10 for which the clip 100 is sized to fit. To facilitate abutment with the equine hoof surface, the outer retaining clip 110 is inclined inward towards the center of the planar base portion 102, as best seen in FIG. 6. Preferably, the planar base portion 102, the inner retaining clip 108, and the outer retaining clip 110 are of a unitary construction, such as formed from a stamped metal sheet.

During use, a clip 100 is fitted to bottom 10B of the horseshoe 10 in a “snap” or “clamp” style engagement at the desired position. As is best seen in FIG. 6, the inward inclines of the inner retaining clip 108 and the outer retaining clip 110 define a decreasing spacing there between, and must be resiliently displaced or deflected outward for engagement with the inner and outer peripheral edges 10C and 10D of a horseshoe 10. The outward deflection of the inner retaining clip 108 and the outer retaining clip 110 to engage the horseshoe 10 provides a clamping or gripping force which retains the clip 100 in engagement with the horseshoe 10 during use.

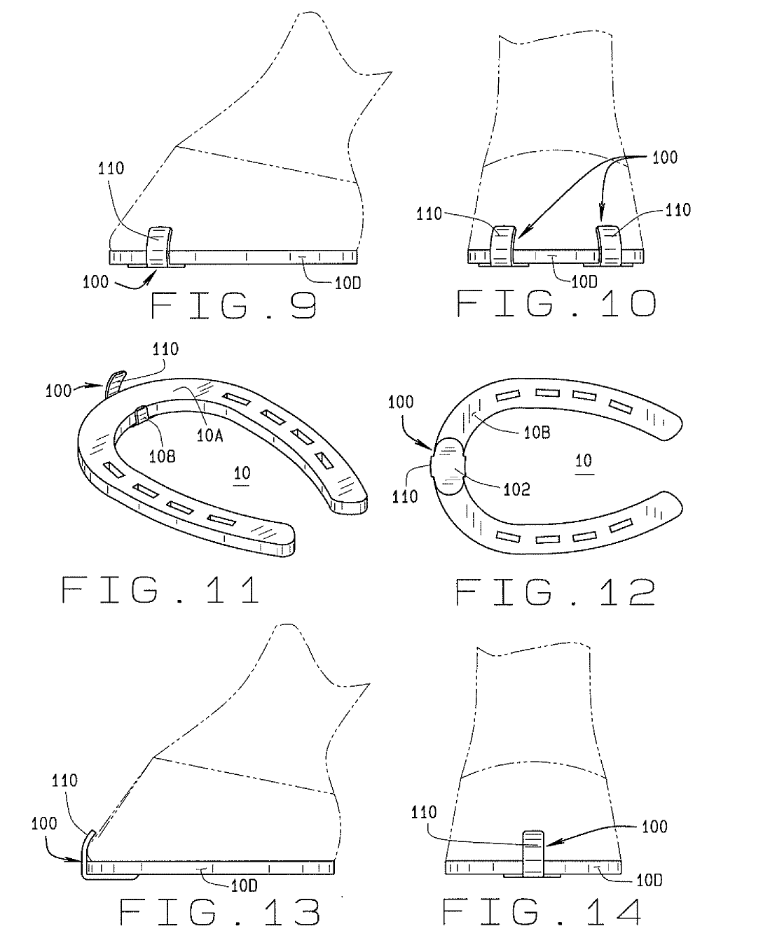

Preferably, as shown in FIGS. 7-10, two clips 100 are fitted to the bottom surface 10B a horseshoe 10 in a generally mirror-image configuration about a longitudinal midline of the horseshoe 10. The specific placement of the clips 100 may be varied as required to accommodate nail holes within the horseshoe 10, or features of the equine hoof onto which the horseshoe 10 is to be affixed. In generally, the function of the clips 100 is to provide an abutting engagement between the outer retaining clips 100 and the outer surface of the equine hoof, as shown in FIGS. 9 and 10, such that the position of the horseshoe 10 adjacent the underside surface of the equine hoof is stabilized against at least backwards sliding movement and/or rotating/pivoting movement when a nail is driven through a nail hole in the horseshoe 10 and into the equine hoof. The inclination of the outer retaining clip 110 may be adjusted by bending to conform to the inclination of the outer hoof surface as required.

In an alternate use, as shown in FIGS. 11-14, a single clip 100 is fitted to the bottom surface 10B a horseshoe 10 generally on a longitudinal midline of the horseshoe 10 at the toe. In generally, the function of the single clip 100 is to provide an abutting engagement between the outer retaining clip 100 and the outer surface of the equine hoof, as shown in FIGS. 13 and 14, such that the position of the horseshoe 10 adjacent the underside surface of the equine hoof is stabilized against backwards sliding movement when a nail is driven through a nail hole in the horseshoe 10 and into the equine hoof. The inclination of the outer retaining clip 110 may be adjusted by bending to conform to the inclination of the outer hoof surface as required.

After the horseshoe 10 is affixed to the equine hoof by a sufficient number of or other attachment means, the clips 100 are be removed. To remove the clips 100, the outer retaining clip 110 may be hammered or levered down the outer surface of the equine hoof, releasing the planar base 102 from contact with the horseshoe bottom surface 10B and “popping” the clip 100 free from engagement with the horseshoe 10. As required, the inner retaining clip 108 and the outer retaining clip 110 may be re-bent or inclined in the inward direction to maintain a desired amount of clamping force or pressure when affixed to a horseshoe 10, as repeated usage will likely result in an outward bending of the retaining clips 108, 110 and a reduced clamping force or pressure.

Those of ordinary skill in the art will recognize that horseshoe 10 are produced in a variety of sizes, having different thicknesses and widths depending upon the particular use for the horseshoe 10 is intended. Accordingly, it will be understood that the clips 100 of the present disclosure may be manufactured in a wide range of dimensions which will be varied according to the particular size of horseshoe 10 for which the clip 10 is intended to be used. For example, the transverse width of the planar base portion 102 may be varied to accommodate horseshoes 10 having a narrow width, as well as horseshoes 10 have a wide width. Similarly, the overall height of the inner retaining clip 108 and outer retaining clip 110 may be varied to accommodate horseshoes 10 having a small vertical thickness as well as horseshoes 10 having a large vertical thickness. Such variations in dimensions as required for use with different horseshoes 10 are considered to be within the scope of this disclosure.

Similarly, the specific size and number of the inner and outer retaining clips 108, 110 may be varied without departing from the scope of the invention. For example, the single outer retaining clip 110 shown in middle of the outer peripheral edge 106 of FIG. 3 may be replaced by a pair of outer retaining clips spaced apart across the length of the outer peripheral edge 106, such that a single clip 100 may be used to provide abutting contact to a plurality of points on the outer surface of an equine hoof during use. Alternatively, either the inner or outer retaining clips 108, 110 may have a width which corresponds to the entire length of either the inner or outer peripheral edges 104, 106 of the planar base 102.

Those of ordinary skill will further recognize that the specific materials from which the clip 100 is manufactured may be varied according to need. Since it is intended that the clip 100 be reusable, and that the retaining tabs retain a degree of resilience upon bending, a metal is a preferred material.

As various changes could be made in the above constructions without departing from the scope of the disclosure, it is intended that all matter contained in the above description or shown in the accompanying drawings shall be interpreted as illustrative and not in a limiting sense.

1. A removable horseshoe clip adapted for temporary placement on a horseshoe having a top surface, a bottom surface, an inner peripheral surface, and an outer peripheral surface during fitment and attachment of the horseshoe to an equine hoof, comprising:
a planar base portion having an inner peripheral edge adapted to align with an inner peripheral edge of the horseshoe, and an outer peripheral edge adapted to align with an outer peripheral edge of the horseshoe;
at least one inner retaining clip disposed adjacent said inner peripheral edge, said inner retaining clip configured to engage an inner peripheral surface of the horseshoe;
at least one outer retaining clip disposed adjacent said outer peripheral edge, said outer retaining clip configured to abut an outer peripheral surface of the horseshoe, said outer retaining clip having a height which exceeds the vertical thickness of the horseshoe such that a portion of said outer retaining clip extends above said upper surface of said horseshoe and is adapted for abutting engagement with a outer surface of an equine hoof during a fitment and attachment procedure to facilitate maintaining said horseshoe position during said fitment and attachment procedure.

2. The removable horseshoe clip of claim 1 wherein said inner retaining clip and said outer retaining clip are inwardly inclined toward each other, whereby said inner and outer retaining clips are adapted to clamp said planar base portion against a bottom surface of the horseshoe.

3. The removable horseshoe clip of claim 1 wherein said inner retaining clip is biased towards said outer retaining clip.

4. The removable horseshoe clip of claim 1 wherein said inner retaining clip, said planar base portion, and said outer retaining clip are integrally formed.

5. The removable horseshoe clip of claim 1 wherein said inner retaining clip, said planar base portion, and said outer retaining clip are formed from metal.

6. The removable horseshoe clip of claim 1 wherein said planar base portion is elongated longitudinally, and has a longitudinal curvature generally aligned with a longitudinal curvature of the horseshoe bottom surface.

7. The removable horseshoe clip of claim 1 wherein said inner retaining clip and said outer retaining clip have equal widths.

8. The removable horseshoe clip of claim 1 further including a second outer retaining clip disposed adjacent said outer peripheral edge, said second outer retaining clip configured to abut said outer peripheral surface of the horseshoe, said second outer retaining clip having a height which exceeds the vertical thickness of the horseshoe such that a portion of said second outer retaining clip extends above said upper surface of said horseshoe and is adapted for abutting engagement with said outer surface of an equine hoof during a fitment and attachment procedure; and
wherein said at least one outer retaining clip and said second outer retaining clip are spaced apart from each other along said outer peripheral edge.

9. The removable horseshoe clip of claim 1 further including a second inner retaining clip disposed adjacent said inner peripheral edge, said second inner retaining clip configured to engage an inner peripheral surface of the horseshoe; and
wherein said at least one inner retaining clip and said second inner retaining clip are spaced apart from each other along said inner peripheral edge.

10. A method for maintaining placement of a horseshoe against an equine hoof surface during attachment thereto, following sizing and placement determination, comprising:
securing at least one removable horseshoe clip to said horseshoe by positioning a planar base portion of said clip against a bottom surface of said horseshoe and engaging inner and outer peripheral surfaces of said horseshoe between an inner retaining clip and an outer retaining clip of said at least one removable horseshoe clip;
positioning said horseshoe in said determined placement against the equine hoof surface;
abutting a portion of said outer retaining clip on said at least one removable horseshoe clip against an outer surface of said equine hoof, whereby said abutting portion resists at least sliding movement of said horseshoe relative to said equine hoof;
affixing said horseshoe to the equine hoof; and
releasing said at least one removable horseshoe clip from engagement with said affixed horseshoe and from said abutment with said equine hoof outer surface.

11. The method of claim 10 where said step of securing further includes securing a second removable horseshoe clip to said horseshoe by positioning a planar base portion of said second clip against a bottom surface of said horseshoe and engaging inner and outer peripheral surfaces of said horseshoe between an inner retaining clip and an outer retaining clip of said second removable horseshoe clip; and
wherein said step of releasing further includes releasing said second removable horseshoe clip from engagement with said horseshoe and from said abutment with said equine hoof outer surface.

12. The method of claim 11 wherein said at least one removable horseshoe clip and said second removable horseshoe clip are secured to said horseshoe in a spaced apart configuration.

13. The method of claim 11 wherein said at least one removable horseshoe clip and said second removable horseshoe clip are secured to said horseshoe in substantially mirror-image positions about a midline of said horseshoe.

14. The method of claim 10 wherein said horseshoe is a clip-less horseshoe, and wherein said at least one removable horseshoe clip is secured to said horseshoe in a position whereby said abutting portion resists at least backward sliding movement of said horseshoe relative to said equine hoof.

15. The method of claim 10 wherein said horseshoe includes at least one permanent clip, and wherein said at least one removable horseshoe clip is secured to said horseshoe in a position whereby said abutting portion resists at least lateral sliding movement of a heel portion of said horseshoe relative to said equine hoof.
